(19) United States
(12) Patent Application Publication
(10) Pub. No.: US 2006/0132019 A1
(43) Pub. Date: Jun. 22, 2006

(54) Funnel for use in a cathode ray tube

(75) Inventor: Jung Mook Kim, Kyungki-do (KR)

Correspondence Address: BACON & THOMAS, PLLC, 625 SLATERS LANE, FOURTH FLOOR, ALEXANDRIA, VA, 22314, US

(73) Assignee: Samsung Corning Co., Ltd., Kyungki-do (KR)

(21) Appl. No.: 11/194,671

(22) Filed: Aug. 2, 2005

(30) Foreign Application Priority Data
Dec. 21, 2004 (KR) 10-2004-0109787
Jun. 27, 2005 (KR) 10-2005-0055680

(51) Int. Cl. H01J 29/86

(52) U.S. Cl. 313/477 R

(57) ABSTRACT

A funnel for use in a cathode ray tube having a panel and a neck includes a body portion connected to the panel; and a substantially rectangle shaped yoke portion extending from a rear end of the body portion, and being connected to the neck at a rear end thereof. The yoke portion has a circular section portion whose cross section is substantially circular. And the circular section portion is formed at a position where the yoke portion is cut for a salvage process of the funnel.

### FIELD OF THE INVENTION

The present invention relates to a funnel for use in a cathode ray tube; and, more particularly, to a funnel for use in a cathode ray tube, which has a rectangle shaped yoke portion, and which is capable of improving a junction quality and a funnel salvage yield by forming a circular section portion at a cutting position of the yoke portion where an end portion of the yoke portion connected to a neck is cut off in a funnel salvage process.

### BACKGROUND OF THE INVENTION

A glass bulb employed in a cathode ray tube for use in manufacturing a color television, a computer monitor, and the like basically includes three main components, i.e., a panel for displaying images thereon, a conical funnel connected to a backside of the panel and a cylindrical neck connected to an apex portion of the funnel. The panel, the funnel and the neck are formed of glass, and particularly the panel and the funnel are fabricated by press forming a lump of molten glass called a glass gob into desired sizes and shapes.

Referring to FIGS. 1 to 3, there is illustrated a general configuration of a conventional cathode ray tube. A panel 20 of a glass bulb 10 includes a face portion 21 for displaying images thereon; a skirt portion 23 extending backwards from a periphery of the face portion 21 and having a seal edge 22; and a blend radius portion 24 for connecting the face portion 21 with the skirt portion 23.

A funnel 30 includes a body portion 32 having a seal edge 31 connected to the seal edge 22 of the panel 20 and a yoke portion 33 extending from a rear end of the body portion 32. A top of round (TOR) portion 34 of the funnel 30, which is indicated by center line in FIG. 1, represents a position where the body portion 32 and the yoke portion 33 start. Further, a seal edge 35 is formed at an end of the yoke portion 33, and a seal edge 41 of a neck 40 is connected to the seal edge 35 of the yoke portion 33.

A shadow mask 50 having a plurality of holes (not shown) is supported at the skirt portion 23 of the panel 20 by stud pins 51. Installed at the neck 40 is an electron gun 60 for emitting electron beams to an image-forming fluorescent material coated on an inner surface of the face portion 21 through the holes of the shadow mask 50.

The yoke portion 33 of the funnel 30 can be of a circle shape or a rectangle shape. The latter is more frequently adopted in the funnel 30 due to its power consumption reduction effect. As shown in FIGS. 2 and 3, a cross section of the rectangle shaped yoke portion 33 changes from a rectangle shape to a circular shape as it moves from the TOR portion 34 toward the seal edge 35.

When the seal edge 41 of the neck 40 is being connected to the seal edge 35 of the yoke portion 33, a badness, such as a neck tilt and a neck run out, may occur, wherein the neck tilt means that the neck 40 is slantingly attached to the funnel 30, and the neck run out means that a central axis of the neck 10 is deviated from a tube axis 11 of the glass bulb 10 (or a cathode ray tube). In this case, the funnel 30 is reworked or salvaged by removing the neck 40 badly attached to the funnel 30 then by attaching a new neck 40 to a cut edge 33a of the funnel 30, thereby improving the productivity. At this time, a 2^{nd} junction line L2 is formed by cutting the yoke portion 33 at a cutting position spaced apart from a 1^{st} junction line L1 to the body portion 32 by about 3 to 4 mm, and the new neck 40 is attached to the cut edge 33a of the yoke portion 33 where the 2^{nd} junction line passes, that is, where the yoke portion 33 is cut.

However, as shown in FIG. 3, in the conventional funnel 30 for a cathode ray tube, due to characteristics of the rectangle shaped yoke portion 33, a cross section formed at the cut edge 33a of the yoke portion 33 where the 2^{nd} junction line passes has not a circular shape but a rectangular shape having rounded corners or an approximately elliptical shape with a large eccentricity. Accordingly, a junction quality of the funnel 30 and the neck 40 considerably deteriorates.

### SUMMARY OF THE INVENTION

It is, therefore, an object of the present invention to provide a funnel for a cathode ray tube, which has a rectangle shaped yoke portion, and which is capable of improving a junction quality of a funnel and a neck in a funnel salvage process and increasing a salvage yield of the funnel salvage process by forming the yoke portion in such a manner as to have a circular cross section at a cutting position where a 2^{nd} junction line passes, wherein the cutting position of the yoke portion is spaced apart from a 1^{st} junction line to a body portion by a predetermined distance.

In accordance with the present invention, there is provided a funnel for use in a cathode ray tube having a panel and a neck, including: a body portion connected to the panel; and a substantially rectangle shaped yoke portion extending from a rear end of the body portion, and being connected to the neck at a rear end thereof, wherein the yoke portion includes a circular section portion whose cross section is substantially circular, and the circular section portion is formed at a position where the yoke portion is cut for a salvage process of the funnel.

### BRIEF DESCRIPTION OF THE DRAWINGS

The above and other objects and features of the present invention will become apparent from the following description of preferred embodiments, given in conjunction with the accompanying drawings, in which:

FIG. 1 is a cross-sectional view of a conventional cathode ray tube;

FIG. 2 shows a partial cross-sectional view taken along line II-II of FIG. 1;

FIG. 3 illustrates a partial cross-sectional view taken along line III-III of FIG. 3;

FIG. 4 provides a cross-sectional view of a funnel for a cathode ray tube in accordance with a preferred embodiment of the present invention;

FIG. 5 describes a partial cross-sectional view of an exemplary circular section portion of the funnel for a cathode ray tube in accordance with the preferred embodiment of the present invention;

FIG. 6 presents a partial cross-sectional view taken along line VI-VI of FIG. 5;

FIG. 7 represents a partial cross-sectional view of another exemplary circular section portion of the funnel for a cathode ray tube in accordance with the preferred embodiment of the present invention; and

FIG. 8 offers a partial cross-sectional view taken along line VIII-VIII of FIG. 4.

### DETAILED DESCRIPTION OF THE PREFERRED EMBODIMENT

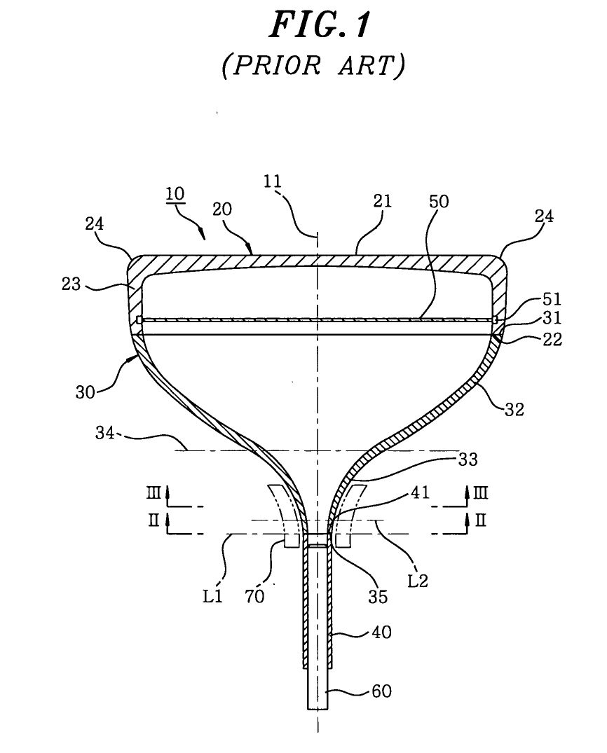

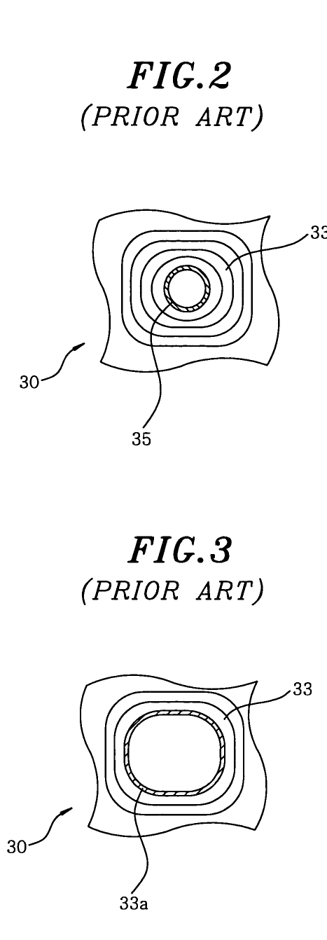

Hereinafter, a funnel for a cathode ray tube in accordance with a preferred embodiment of the present invention will be described in detail with reference to the accompanying drawings, wherein like parts to those of the conventional cathode ray tube shown in FIG. 1 are represented by like reference notations.

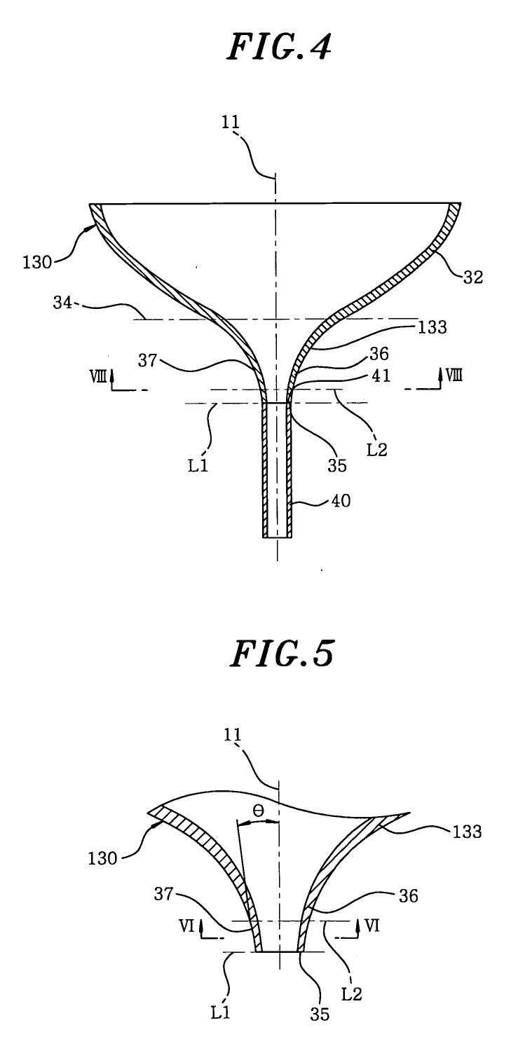

Referring to FIG. 4, a funnel 130 for a cathode ray tube includes a body portion 32 connected to a panel and a rectangle shaped yoke portion 133 extending from a rear end of the body portion 32. A seal edge 35 is formed at an end of the yoke portion 133, and a seal edge 41 of a neck 40 is connected to the seal edge 35 of the yoke portion 133. The cross sections of the funnel 130 and the neck 40 where the 1^{st} conjunction line L1 passes and where the seal edges 35 and 41 are bonded to each other are circular.

Further, the funnel 130 with the rectangle shaped yoke portion 133 has a circular section portion 36, which has a substantially circular cross section and which is formed in an entire part ranging from the seal edge 35 to a position spaced apart from the seal edge 35 toward the body portion 32 by about 10 mm, preferably about 6 mm, or in at least one portion of the part. Moreover, the cross section 36a (see FIG. 6) of the circular section portion 36 is preferably formed in a perfect circle.

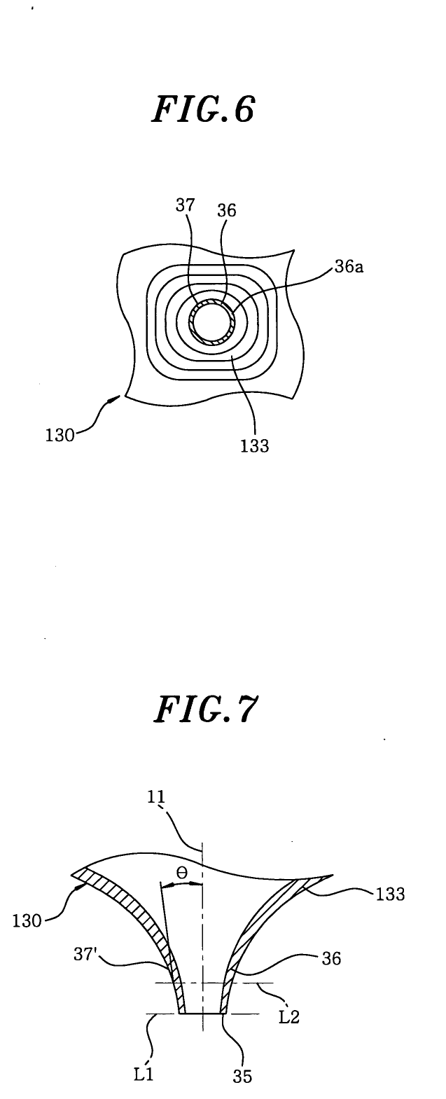

Referring to FIGS. 5 and 6, an outer contour 37 of the circular section portion 36 is formed in a straight line segment. The straight outer contour 37 is parallel to a tube axis 11 of the glass bulb (or a cathode ray tube) or slants with respect to the tube axis 11 at a predetermined slope angle θ. More specifically, the straight line parallel to the straight outer contour 37 slants outwards from the yoke portion 133 to the body portion 32. Further, the slope angle θ formed by the straight outer contour 37 and the tube axis 11 ranges from about 0° to 10°. Herein, the slope angle θ of 0° means that the straight outer contour 37 is parallel to the tube axis 11. It is preferable that the slope angle θ formed by the straight outer contour 37 and the tube axis 11 ranges from about 2° to 7°.

Further, if the slope angle θ is less than about 0°, that is, the straight outer contour 37 slants inwards from the yoke portion 133 to the body portion 32, the glass bulb becomes bad since paths of electron beams from an electron gun are blocked. If the slope angle θ is greater than about 10°, the diameter of a cross section of the circular section portion 36 where the 2^{nd} junction line L2 passes becomes far greater than that of the neck 40, so that the junction quality of the funnel 130, i.e., the circular section portion 36 and the neck 40 is deteriorated.

For example, in the funnel 130 for a 32-inch cathode ray tube, if the neck 40 with a diameter of about 29.1 mm is selected, the circular section portion 36 is formed in such a manner as to have a diameter of less than about 30.5 mm in order to achieve the excellent junction quality of the neck 40 and the funnel 130, i.e., the cut edge of the circular section portion 36. Further, if the neck 40 with a diameter of about 32.5 mm is selected, the circular section portion 36 is formed in such a manner as to have a diameter of less than about 34 mm in order to achieve the excellent junction quality of the neck 40 and the funnel 130, i.e., the cut edge of the circular section portion 36. More generally, the diameter R of the circular section portion 36 satisfies a relationship of R≦R₁(1+10%), preferably R≦R₁(1+5%), where R₁ indicates a diameter of the neck 40.

Referring to FIG. 7, an outer contour 37′ of the circular section portion 36 can be formed in a curved line segment in lieu of the straight line segment. The slope angle θ formed by the tube axis 11 and a tangent line positioned at an end of the curved outer contour 37′ near the neck 40 ranges from about 0° to 10°, preferably from about 2° to 7°. Further, the diameter R of the circular section portion 36 having the curved outer contour 37′ satisfies a relationship of R≦R₁(1+10%), preferably R≦R₁(1+5%), where R₁ indicates the diameter of the neck 40.

In addition, the outer contour of the circular section portion 36 can be formed by combining the straight and the curved line segment satisfying the aforementioned conditions.

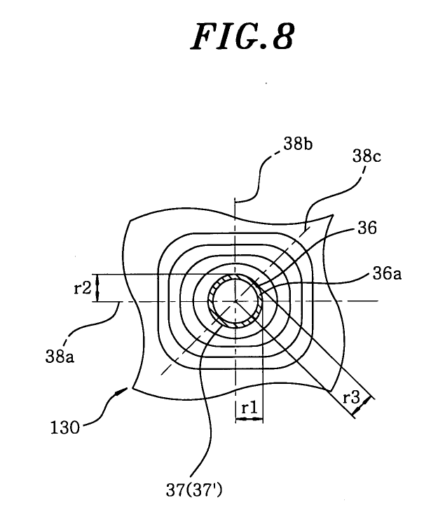

Referring to FIG. 8, the yoke portion 133 of the funnel 130 has a long axis 38a, a short axis 38b and a diagonal axis 38c. A cross section 36a (or cut edge) of the circular section portion 36 is formed in such a manner that a maximum deviation among three radii of the outer periphery of the cross section 36a in directions of the long axis 38a, the short axis 38b and the diagonal axis 38c is less than or equal to about 0.5 mm to satisfy Equation 1. If the maximum deviation of the radii r1, r2 and r3 exceeds 0.5 mm, a diameter difference between the circular section portion 36 and the neck 40 is too large, thereby deteriorating the junction quality thereof.
Max [νr1−r2|, |r1−r3|, |r2−r3|]≦0.5 mm Eq. 1

Hereinafter, a funnel salvage process of the funnel in accordance with the preferred embodiment of the present invention will be described.

When an operator needs to salvage the funnel 130 due to a junction badness of the funnel 130 and the neck 40 such as a neck tilt or neck run out, the circular section portion 36 is cut with a well-known cutter using a thermal shock method at a position where the 2^{nd} junction line L2 passes, wherein the 2^{nd} junction line L2 is positioned about 3 to 6 mm apart from the 1^{st} junction line L1 toward the body portion 32 of the funnel 130, and the 1^{st} junction line L1 passes the position where the seal edge 35 of the funnel 130 and the seal edge 41 of the neck 40 are connected to each other.

Further, a diameter R of the cut edge (or cross section 36a) of the circular section portion 36 cut by the cutter using the thermal shock method satisfies a relationship of R≦R₁(1+10%), preferably R≦R₁(1+5%), where R₁ indicates the diameter of the neck 40. Thus, a new neck 40 is attached to the cut edge of the funnel 130 achieving an excellent quality of a second junction between the funnel 130 and the new neck 40, so that the salvage yield of the funnel 130 can be increased. Further, in case the circular section portion 36 having the curved outer contour 37′ is formed as described in FIG. 7, the salvage yield can also be increased through the aforementioned salvage process of the funnel 130.

In accordance with a funnel for a cathode ray tube of the present invention, a circular section portion having a substantially circular cross section is formed in an entire part of a yoke portion ranging from a 1^{st} junction line passing a position where a funnel having the rectangle shaped yoke portion and a neck have been connected to each other to a position spaced apart from the 1^{st} junction line by a predetermined distance, or formed in at least one portion of the part. Accordingly, a junction quality of the funnel and the neck is improved during a salvage process and, further, a salvage yield is considerably improved.

While the invention has been shown and described with respect to the preferred embodiments, it will be understood by those skilled in the art that various changes and modification may be made without departing from the spirit and scope of the invention as defined in the following claims.

What is claimed is:

1. A funnel for use in a cathode ray tube having a panel and a neck, comprising:
a body portion connected to the panel; and
a substantially rectangle shaped yoke portion extending from a rear end of the body portion, and being connected to the neck at a rear end thereof,
wherein the yoke portion includes a circular section portion whose cross section is substantially circular, and the circular section portion is formed at a position where the yoke portion is cut for a salvage process of the funnel.

2. The funnel of claim 1, wherein the circular section portion is formed in an entire part of the yoke portion ranging from a starting position spaced from the rear end of the yoke portion by about 3 mm to an ending position spaced apart the rear end of the yoke portion by about 10 mm, or formed in at least one portion of the part.

3. The funnel of claim 1, wherein an outer contour of the circular section portion is formed in a straight line segment parallel to a tube axis of the cathode ray tube.

4. The funnel of claim 1, wherein an outer contour of the circular section portion is formed in a straight line segment, and a straight line parallel to the straight line segment slants outwards with respect to a tube axis of the cathode ray tube at a predetermined slope angle from the yoke portion to the body portion.

5. The funnel of claim 4, wherein the slope angle is less than or equal to about 10°.

6. The funnel of claim 1, wherein an outer contour of the circular section portion is formed in a curved line segment, and a straight line tangent to the outer contour at an end of the outer contour near the rear end of the yoke portion slants outwards with respect to a tube axis of the cathode ray tube at a predetermined slope angle from the yoke portion to the body portion.

7. The funnel of claim 6, wherein the slope angle is less than or equal to about 10°.

8. The funnel of claim 1, wherein a diameter R of the circular section portion satisfies a relationship of R≦R₁(1+10%), where R₁ indicates a diameter of the neck.

9. The funnel of claim 1, wherein the circular section portion is formed in such a manner that a maximum deviation among radii of an outer periphery of the cross section in directions of a long axis, a short axis and a diagonal axis is less than or equal to about 0.5 mm.
